(19) United States
(12) Patent Application Publication
(10) Pub. No.: US 2012/0034021 A1
(43) Pub. Date: Feb. 9, 2012

(54) QUICKLY ASSEMBLABLE MORTISE LOCK

(75) Inventor: Gongchun Zhang, Guangzhou City (CN)

(73) Assignee: CMECH (Guangzhou) Industrial Ltd., Guangzhou City (CN)

(21) Appl. No.: 12/956,365

(22) Filed: Nov. 30, 2010

(30) Foreign Application Priority Data
Aug. 4, 2010 (CN) 201020281992.7

(51) Int. Cl. F16B 5/07; F16B 1/00

(52) U.S. Cl. 403/42; 403/408.1

(57) ABSTRACT

A quickly assemblable mortise lock includes a mortise lock body, characterized in that at least one pair of snap-fitting tabs cooperating with a positioning profile is provided symmetrically on a positioning slot plate at both end sides of the mortise lock body, and in that each of the snap-fitting tabs is spaced apart a proper gap from a lateral cover plate of the mortise lock body. As compared with the prior art, the quickly assemblable mortise lock has the following advantageous effects: 1. the mortise lock is overally simpler in structure and easy to make, and can be processed on the basis of the prior art mortise locks, thereby reducing the production cost; and 2. the mortise lock is universally useable, conveniently and quickly assemblable, and time-saving and labor-saving, thereby improving the efficiency.

### CROSS-REFERENCE TO RELATED APPLICATION

The present application claims priority of Chinese Patent Application CN 201020281992.7 filed Aug. 4, 2010, the entire contents of which is incorporated herein by reference.

### FIELD OF THE INVENTION

The present invention relates to a mortise lock, belonging to door or window anti-theft apparatuses, and particularly to a quickly assemblable mortise lock.

### BACKGROUND OF THE INVENTION

In the prior art, there are diverse door or window locks with different functions and effects, wherein a mortise lock is a relatively conventional lock which is utilized in a broader scope due to a simpler structure, less costs and a lower price in the market. However, the prior art mortise locks are relatively troublesome upon assembly: a screw hole needs to be opened on a lateral end face of a door body, and then a mortise lock body is positioned and fixed on the door body trough screws (as shown in FIG. 1). The assembling procedure is time-consuming and requires more efforts. Furthermore, if there is a slight deviation with the screw holes, the mortise lock body cannot be accurately positioned and new screw holes need to be opened, which might cause damages to the door body.

### SUMMARY OF THE INVENTION

An object of the present invention is to overcome the drawbacks and shortcomings in the prior art and to provide a mortise lock which is structurally simpler, easier to make and quickly assemblable.

To achieve the above object, the present invention employs the following technical solution:

A quickly assemblable mortise lock comprises a mortise lock body, at least one pair of snap-fitting tabs cooperating with a positioning profile being provided symmetrically on a positioning slot plate at both end sides of the mortise lock body, each of the snap-fitting tabs being spaced apart a proper gap from a lateral cover plate of the mortise lock body.

Furthermore, a pair of snap-fitting tabs cooperating with a positioning profile is provided symmetrically at an upper end of the positioning slot plate at both end sides of the mortise lock body, each of the snap-fitting tabs being spaced apart a proper gap from a lateral cover plate of the mortise lock body. Preferably, a snap-fitting notch for snap-fitting with the positioning profile is provided on the bottom of the mortise lock body and at a position where the lateral cover plate joins with the positioning slot plate.

Furthermore, a pair of snap-fitting tabs cooperating with the positioning profile is provided symmetrically respectively at an upper end and a lower end of a positioning slot plate on both end sides of the mortise lock body, each of the snap-fitting tabs being spaced apart a proper gap from the lateral cover plate of the mortise lock body.

Furthermore, a plurality of positioning projections abutting against a frame of the positioning profile to prevent swing of the mortise lock body are provided on the positioning slot plate on both end sides of the mortise lock body.

As compared with the prior art, the present invention has the following advantageous effects:

1. The mortise lock is overally simpler in structure and easy to make, and can be processed on the basis of the prior art mortise locks, thereby reducing the production cost;

2. The mortise lock is universally useable, conveniently and quickly assemblable, and time-saving and labor-saving, thereby improving the efficiency.

In order to make the present invention apparent, preferred embodiments of the present invention are described and illustrated with reference to the drawings.

### BRIEF DESCRIPTION OF THE ACCOMPANYING DRAWINGS

FIG. 1 is an exploded view showing assembly of a mortise lock in the prior art;

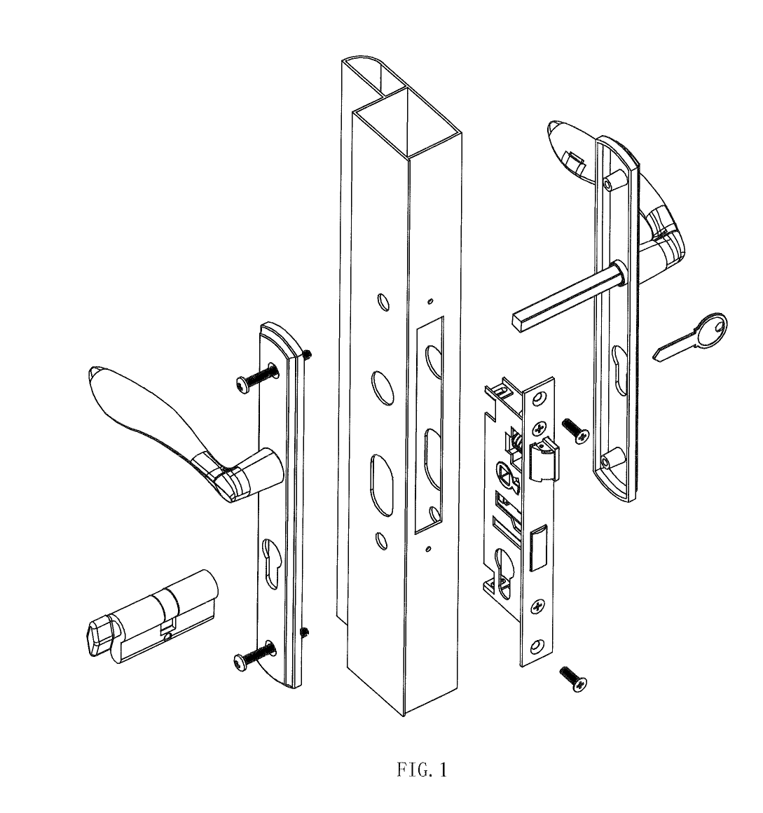

FIG. 2 is an exploded view showing assembly of a mortise lock according to a first embodiment of the present invention;

FIG. 3 is a schematic view of a mortise lock body of FIG. 2;

FIG. 4 is an exploded view showing assembly of a mortise lock according to a second embodiment of the present invention; and

FIG. 5 is a schematic view of a mortise lock body of FIG. 4.

### DETAILED DESCRIPTION OF THE PREFERRED EMBODIMENTS

### Embodiment 1

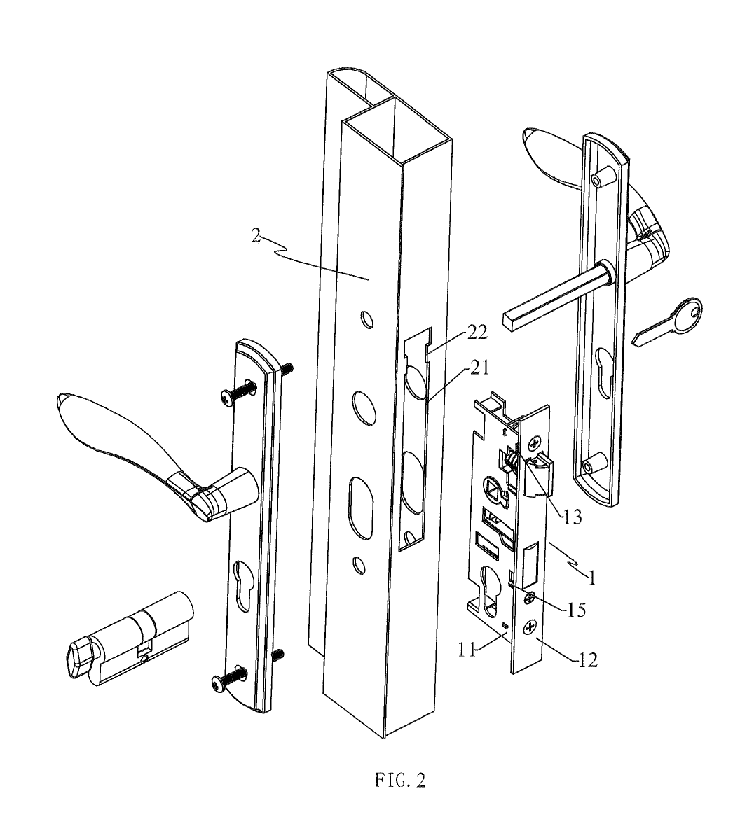

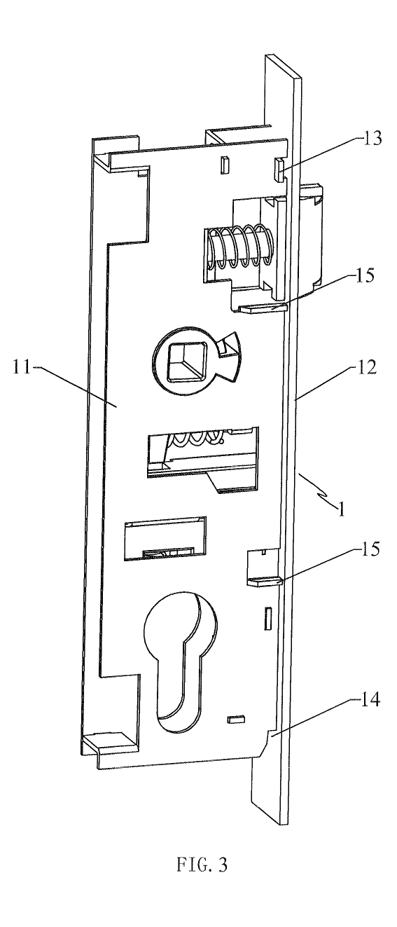

As shown in FIG. 2 and FIG. 3, a quickly assemblable mortise lock according to the present invention comprises a mortise lock body 1, a pair of snap-fitting tabs 13 cooperating with a positioning profile 2 being provided symmetrically at an upper end of a positioning slot plate 11 at both end sides of the mortise lock body 1, each of the snap-fitting tabs 13 being spaced apart a proper gap from a lateral cover plate 12 of the mortise lock body. Preferably, a snap-fitting notch 14 for snap-fitting with the positioning profile 2 is provided on the bottom of the mortise lock body 1 and at a position where the lateral cover plate 12 joins with the positioning slot plate 1.

Furthermore, a plurality of positioning projections 15 abutting against a frame of the positioning profile 2 to prevent swing of the mortise lock body 1 are provided on the positioning slot plate 11 on both end sides of the mortise lock body 1.

Upon assembly, firstly a mortise lock body mounting slot 21 is punched on a lateral end face of the positioning profile 2, a protrusion 22 snap-fitting with the snap-fitting tab 13 on the mortise lock body is unitarily punched on the frame of the mounting slot 21, then the mortise lock body 1 is inserted into the mounting slot 21 in the positioning profile, then the mortise lock body 1 is enabled to slide downwardly, the frame of the mounting slot 21 in the positioning profile is right snap-fitted in the snap-fitting notch 14 of the mortise lock body 1, meanwhile, the protrusion 22 on the mounting slot 21 is right snap-fitted in the gap between the snap-fitting tab 13 and the lateral cover plate 12 of the mortise lock body 1, the positioning projections 15 of the mortise lock body 1 abut against and cooperate with the frame of the mounting slot 21 in the positioning profile, thereby positioning the mortise lock body 1 on the positioning profile 2, then a handle or other parts are assembled to complete the assembly of the mortise lock. The assembly of the mortise lock is convenient and quick, time-saving and labor-saving.

### Embodiment 2

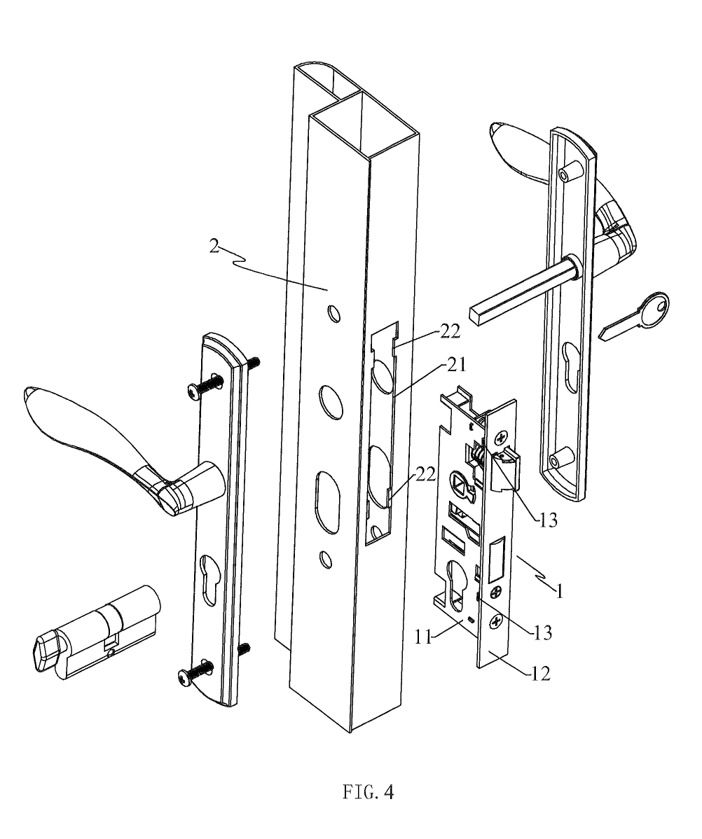

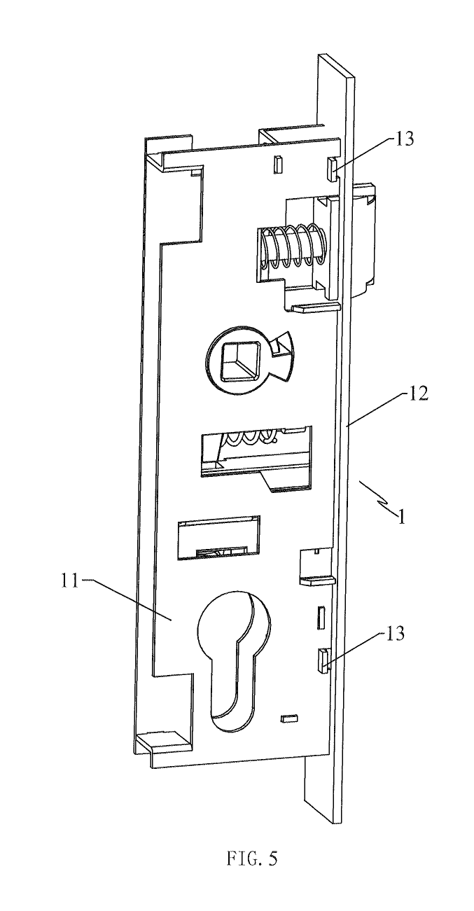

As shown in FIGS. 4 and FIG. 5, the implementation mode shown in Embodiment 2 is substantially identical with that in Embodiment 1. The only difference lies in that: a pair of snap-fitting tabs 13 cooperating with a positioning profile 2 are provided symmetrically respectively at an upper end and a lower end of a positioning slot plate 11 on both end sides of the mortise lock body 1, each of the snap-fitting tabs 13 being spaced apart a proper gap from a lateral cover plate 12 of the mortise lock body. On the bottom of the mortise lock body 1 is not provided a snap-fitting notch. Upon assembly, the mortise lock body 1 can be quickly positioned and fixed on the positioning profile 2 by allowing the two pairs of snap-fitting tab 13 in cooperation with protrusions 22 on a mounting slot 21 in the positioning profile. The assembling procedure is also time-saving and labor-saving.

The present invention is not limited to the above embodiments. If various modification or variations to the present invention do not depart from the spirit and scope of the present invention, the present invention also intends to contain the various modifications and variations if they fall within the scope of claims of the present invention and equivalent technologies.

What is claimed is:

1. A quickly assemblable mortise lock comprising a mortise lock body, characterized in that at least one pair of snap-fitting tabs cooperating with a positioning profile is provided symmetrically on a positioning slot plate at both end sides of the mortise lock body, and in that each of the snap-fitting tabs is spaced apart a proper gap from a lateral cover plate of the mortise lock body.

2. The quickly assemblable mortise lock according to claim 1, characterized in that a pair of snap-fitting tabs cooperating with the positioning profile are provided symmetrically at an upper end of the positioning slot plate at both end sides of the mortise lock body, and in that each of the snap-fitting tabs is spaced apart a proper gap from the lateral cover plate of the mortise lock body.

3. The quickly assemblable mortise lock according to claim 2, characterized in that a snap-fitting notch for snap-fitting with the positioning profile is provided on the bottom of the mortise lock body and at a position where the lateral cover plate joins with the positioning slot plate.

4. The quickly assemblable mortise lock according to claim 1, characterized in that
a pair of snap-fitting tabs cooperating with the positioning profile is provided symmetrically respectively at an upper end and a lower end of the positioning slot plate on both end sides of the mortise lock body, and each of the snap-fitting tabs is spaced apart a proper gap from the lateral cover plate of the mortise lock body.

5. The quickly assemblable mortise lock according to claim 1, characterized in that a plurality of positioning projections abutting against a frame of the positioning profile to prevent swing of the mortise lock body are provided on the positioning slot plate on both end sides of the mortise lock body.

6. The quickly assemblable mortise lock according to claim 2, characterized in that a plurality of positioning projections abutting against a frame of the positioning profile to prevent swing of the mortise lock body are provided on the positioning slot plate on both end sides of the mortise lock body.

7. The quickly assemblable mortise lock according to claim 3, characterized in that a plurality of positioning projections abutting against a frame of the positioning profile to prevent swing of the mortise lock body are provided on the positioning slot plate on both end sides of the mortise lock body.

8. The quickly assemblable mortise lock according to claim 4, characterized in that a plurality of positioning projections abutting against a frame of the positioning profile to prevent swing of the mortise lock body are provided on the positioning slot plate on both end sides of the mortise lock body.
